(19) United States
(12) Patent Application Publication
(10) Pub. No.: US 2021/0281766 A1
(43) Pub. Date: Sep. 9, 2021

(54) CONTROL DEVICE, CAMERA DEVICE, CAMERA SYSTEM, CONTROL METHOD AND PROGRAM

(71) Applicant: SZ DJI TECHNOLOGY CO., LTD., Shenzhen (CN)

(72) Inventors: Hailong LU, Shenzhen (CN); Linglong ZHU, Shenzhen (CN)

(73) Assignee: SZ DJI TECHNOLOGY CO., LTD., Shenzhen (CN)

(21) Appl. No.: 17/308,998

(22) Filed: May 6, 2021

Related U.S. Application Data
(63) Continuation of application No. PCT/CN2020/092927, filed on May 28, 2020.

(30) Foreign Application Priority Data
Jun. 4, 2019 (JP) 2019-104122

(51) Int. Cl. H04N 5/232; G03B 17/56

(52) U.S. Cl. CPC H04N 5/232127; G03B 17/561; H04N 5/232122; H04N 5/23299

(57) ABSTRACT

A control device includes a circuit configured to derive a plurality of focus state values representing focus states for each region of a plurality of regions within an image captured by a camera device, and perform a focusing control of the camera device based on a value of the plurality of focus state values representing a closest focus state.

### CROSS-REFERENCE TO RELATED APPLICATIONS

The present application is a continuation of International Application No. PCT/CN2020/092927, filed May 28, 2020, which claims priority to Japanese Patent Application No. 2019-104122, filed Jun. 4, 2019, the entire contents of each are incorporated herein by reference.

### TECHNICAL FIELD

The present disclosure relates to a control device, a camera device, a camera system, a control method, and a program.

### BACKGROUND

In patent document, Japanese Patent Publication No. 2019-20544, the size of the auto focus (AF) region can be set according to the subject location, the subject moving distance, and the subject speed.

However, when the object is lost from the image, the AF region may not be able to be processed before the object is detected again in the image and therefore the AF process may take a relatively long time. Sometimes the AF process may be performed directly in the AF region without the subject.

### SUMMARY

Embodiments of the present disclosure provide a control device, a camera device, a camera system, a control method, and/or a control program.

In an aspect of the present disclosure, the present disclosure provides a control device. The control device can include circuitry configured to derive a plurality of focus state values representing focus states for each region of a plurality of regions within an image captured by a camera device, and perform a focusing control of the camera device based on a value of the plurality of focus state values representing a closest focus state.

The circuit can be configured to determine a subject satisfying a preset condition based on the image captured by the camera device, perform the focusing control to focus on the subject, and derive the plurality of focus state values for each region of the plurality of regions that includes a first region in which the subject is located.

The camera device can be mounted on a support mechanism configured to control a posture of the camera device, and the support mechanism can control the posture of the camera device to make the subject located in the first region. The first region may correspond to a central region of the image captured by the camera device. A face may be located in the first region in the image captured by the camera device.

The circuitry can be configured to rotate the camera device around at least one of a roller axis, a pitch axis, and a yaw axis, by use of the support mechanism.

The circuitry can be configured to cause a change in the posture of the camera device to track a posture change of a base of the support mechanism.

The circuitry can be configured to cause the support mechanism to act such that the posture of the camera device is maintained.

The circuitry can be configured to compensate the value representing the closest focus state based on control information associated with the support mechanism, and can perform the focusing control based on the compensated value.

The circuitry can be configured to compensate the value representing the closest focus state based on a positional relationship between a position of the subject determined by the image captured by the camera device and a region corresponding to the value representing the closest focus state, and can perform the focusing control based on the compensated value.

The circuitry can be configured to perform the focusing control by an automatic focusing control based on a phase difference.

At least two of the plurality of regions can be partially overlapped.

The plurality of regions can include a first region preset in the image, a second region located within the first region in a first direction, a third region located within the first region in a second direction opposite the first direction, a fourth region located within the second region in the first direction, a fifth region located within the third region in the second direction, a sixth region located within the first region in a third direction, a seventh region located within the second region in a fourth direction opposite the third direction, and/or an eighth region located within the third region in the fourth direction.

The second region can partially overlap the first region and the fourth region, and/or the third region can partially overlap the first region and the fifth region.

The first region can be in a central region of the image. In another aspect, the value of the plurality of focus state values representing the closest focus state can be a minimum value of respective values corresponding to the plurality of focus states.

In another aspect of the present disclosure, a camera device is disclosed. The camera device can include a control device having circuitry configured to: derive a plurality of focus state values representing focus states for each region of a plurality of regions within an image, and perform a focusing control of the camera device based on a value of the plurality of focus state values representing a closest focus state; a focusing lens configured to be controlled by the control device; and an image sensor configured to capture the image.

In a further aspect of the present disclosure, a camera system is disclosed. The camera system can include the above-mentioned camera device, and a supporting mechanism configured to control the posture of the camera device.

In still a further aspect of the present disclosure, an image capturing method is disclosed. The image capturing method can include deriving a plurality of focus state values representing focus states for each region of a plurality of regions within an image captured by a camera device, and performing a focusing control of the camera device based on a value of the plurality of focus state values representing a closest focus state. One or both of the foregoing operations can be performed using circuitry or one or more electronic processors.

In yet a further aspect of the present disclosure, a program is disclosed. The program can be for causing a computer to function as the above-mentioned control device. The program, i.e., instructions, may be stored on a non-transitory computer-readable storage medium having stored thereon the instructions that, when executed by one or more processors, causes the one or more processors to perform the method or operations discussed above.

According to one aspect of the present disclosure, the focusing control of the camera device can be performed more appropriately. In addition, not all necessary features of the invention are exhaustive in the context of the present disclosure. Further, a subset of these feature groups may also be included in the invention.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 illustrates a perspective view of a camera system according to one or more embodiments of the disclosed subject matter.

FIG. 2 illustrates a schematic diagram of functional blocks of a camera system according to one or more embodiments of the disclosed subject matter.

FIGS. 3A-3E are diagrams for illustrating phase detection auto focus (PDAF) in a tracking mode according to one or more embodiments of the disclosed subject matter.

FIG. 4 is a diagram for illustrating detection of a subject and phase difference data derivation according to one or more embodiments of the disclosed subject matter.

FIG. 5 is a diagram illustrating one example of deriving a plurality of regions of a defocus amount according to one or more embodiments of the disclosed subject matter.

FIG. 6 is a diagram for illustrating PDAF based on a defocus amount of a plurality of regions according to one or more embodiments of the disclosed subject matter.

FIG. 7 is a diagram illustrating one example of temporal variation of defocus amount for various regions according to one or more embodiments of the disclosed subject matter.

FIG. 8 is a flow chart illustrating one example of a focusing control process with a camera controller according to one or more embodiments of the disclosed subject matter.

FIG. 9 is a diagram illustrating compensating the defocus amount based on the control information of a support mechanism according to one or more embodiments of the disclosed subject matter.

FIG. 10 is a schematic diagram illustrating other implementations of a camera system according to one or more embodiments of the disclosed subject matter.

FIG. 11 is a diagram illustrating one example of an appearance of an unmanned aerial vehicle and a remote operating device according to one or more embodiments of the disclosed subject matter.

FIG. 12 is a diagram illustrating one example of a hardware configuration according to one or more embodiments of the disclosed subject matter.

Implementations of the present disclosure will be described with reference to the accompanying drawings.

### DETAILED DESCRIPTION

The technical solutions in the embodiments of the present disclosure will be described in connection with the accompanying drawings in the embodiments of the present disclosure, notably where the described embodiments are merely a part of the disclosure, and not all embodiments. Based on the embodiments of the present disclosure, all other embodiments without creative efforts are within the scope of the present disclosure.

Various embodiments of the invention may be described with reference to flowchart and block diagrams, where a block may represent (1) a stage of performing an operation or (2) a “portion” of a device having an action to perform an operation. Certain stages and “portions” may be implemented by programmable circuitry and/or one or more processors. The dedicated circuitry may include digital and/or analog hardware circuitry. Integrated circuits (ICs) and/or discrete circuits may be included. The programmable circuitry may include reconfigurable hardware circuitry. Reconfigurable hardware circuits may include logical AND, OR, NAND, NOR, XOR or other logical operations, flip-flops, registers, field-programmable gate arrays (FPGAs), programmable logic arrays (PLAs), and the like.

Computer-readable media according to one or more embodiments of the disclosed subject matter, which may be non-transitory, may include any tangible device capable of storing instructions for execution by a suitable device. As a result, a computer-readable medium having instructions stored thereon can include a product comprising instructions that may be executed to perform or otherwise create aspects (e.g., instances) to perform the operations determined by the flowchart or block diagrams. As examples of computer-readable media, electronic storage media, magnetic storage media, optical storage media, electromagnetic storage media, semiconductor storage media, and the like may be included. A more specific example of a computer-readable medium may include floppy disk, hard disk, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disk (DVD), Blu-ray disk, memory stick, integrated circuit card, and the like.

The computer-readable instructions may include any of the source code or the object code described by any combination of one or more programming languages. The source code or object code includes a conventional procedural programming language. Conventional procedural programming languages may be assembly instructions, instruction set architecture (ISA) instructions, machine instructions, machine-related instructions, microcode, firmware instructions, state setting data, or Smalltalk, Java, C++ or the like, object-oriented programming languages, and C programming languages or similar programming languages. The computer readable instructions may be provided to a processor or programmable circuitry of a general-purpose computer, special-purpose computer, or other programmable data processing apparatus either locally or via a wide area network (WAN), such as a local area network (LAN), the Internet, or the like. The processor or programmable circuitry may execute computer-readable instructions to create means for performing the operations specified in the flowchart or block diagrams or blocks. Examples of processors include computer processors, processing units, microprocessors, digital signal processors, controllers, microcontrollers, and the like.

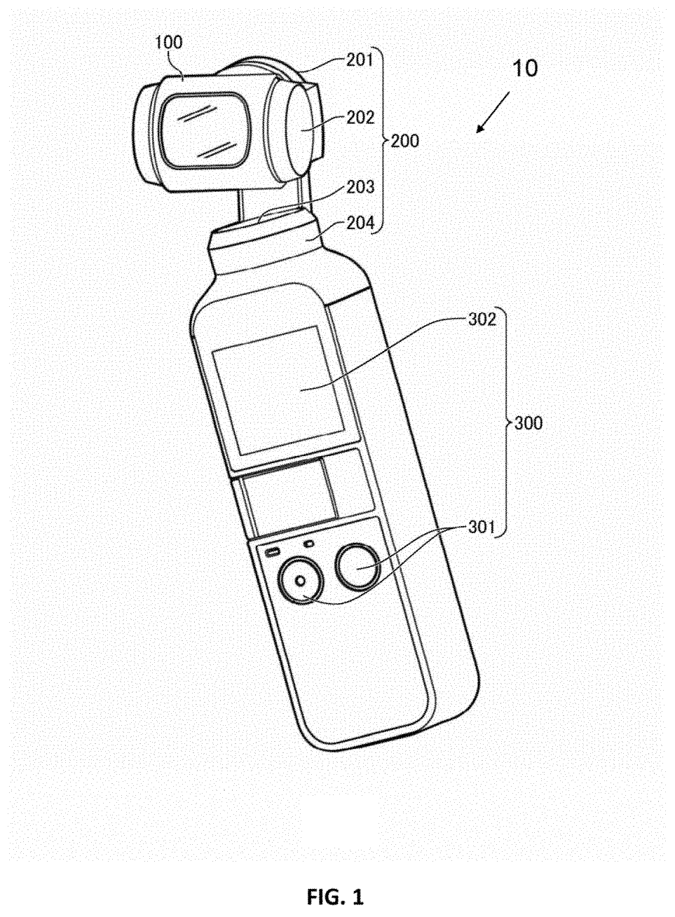

FIG. 1 illustrates a perspective view of a camera system 10 according to one or more embodiments of the present disclosure. The camera system 10 can include a camera device 100, a support mechanism 200, and a holding portion 300. The support mechanism 200 can rotatably support the camera device 100 using actuators as a roller axis, a pitch axis, and a yaw axis, respectively, to change or maintain a posture of the camera device 100 by rotating the camera device 100 with at least one of the roller axis, the pitch axis, and the yaw axis. In some embodiments, the support mechanism 200 can include a roller axis driving mechanism 201, a pitch axis driving mechanism 202, and a yaw axis driving mechanism 203. In some embodiments, the support mechanism 200 can further include a base portion 204 holding the yaw axis driving mechanism 203. The holding portion 300 can be fixed to the base portion 204. In some embodiments, the holding portion 300 can include an operation interface 301 and a display unit or device 302. The camera device 100 can be fixed on the pitch axis driving mechanism 202.

The operation interface 301 can receive commands from a user for operating the camera device 100 and the support mechanism 200. In some embodiments, the operation interface 301 may include a shutter/video button that indicates photographing or recording by the camera device 100. In some embodiments, the operation interface 301 may include a power/function button to turn on or off the power supply of the camera system 10 and to switch between a still image photography mode or a dynamic image photography mode of the camera device 100.

The display unit or device 302 may display an image captured by the camera device 100. In some embodiments, the display unit 302 may display a menu screen to operate the camera device 100 and/or the support mechanism 200. In some embodiments, the display unit 302 may be a touch screen display configured to receive commands to operate the camera device 100 and/or the support mechanism 200.

The user may hold the holding portion 300 to take a still image or a dynamic image by or using the camera device 100. The camera device 100 can perform the focusing control. In some embodiments, the camera device 100 may perform contrast autofocus (contrast AF), phase difference AF, image plane phase difference AF, and/or the like. In some embodiments, the camera device 100 may perform the focusing control by predicting the focus position of the focusing lens by the ambiguity of at least two images captured by the camera device 100.

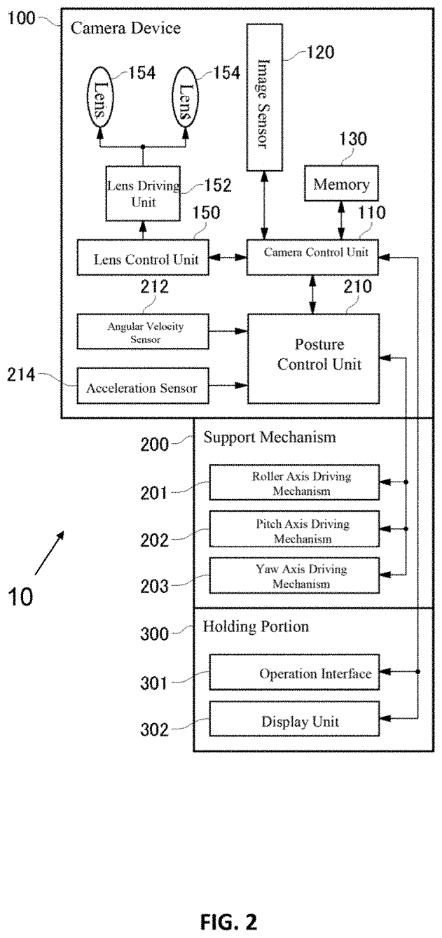

FIG. 2 illustrates a schematic diagram of functional blocks of the camera system 10. The camera device 100 can include a camera control unit or controller 110, an image sensor 120, a memory 130, a lens control unit or controller 150, a lens driving unit or driver 152, and a plurality of lenses 154 (though FIG. 2 shows two lenses 154 embodiments of the disclosed subject matter can include only one lens 154 or more than two lenses 154).

The image sensor 120 may be composed of CCD or CMOS. The image sensor 120 can output the image data of the optical image imaged by the plurality of lenses 154 to the camera control unit 110. In some embodiments, the camera control unit 110 may be composed of a microprocessor, such as a CPU or MPU, a microcontroller (MCU), a system-on-chip (SOC) or the like. The camera control unit 110 is one example of a circuit. In some embodiments, the camera control unit 110 may control the camera device 100 according to the operation instructions of the camera device 100 from the holding portion 300, particularly the operation interface 301 and/or the display unit 302 of the holding portion 300.

The memory 130 may be a computer-readable storage medium, which may be non-transitory, and which may include at least one of SRAM, DRAM, EPROM, EEPROM, and USB memory. The memory 130 can store the program (or programs) required by the camera control unit 110 to control the image sensor 120 or the like. In some embodiments, the memory 130 may be disposed inside the housing of the camera device 100. In some embodiments, the holding portion 300 may include additional memory to store image data captured by the camera device 100. In some embodiments, the holding portion 300 may have a slot capable of removing the memory 130 from the housing of the holding portion 300.

The plurality of lenses 154 may function as a zoom lens, a varifocal lens, and/or a focusing lens. At least a portion or all of the plurality of lenses 154 can be configured to be movable along the optical axis. In some embodiments, the lens control unit 150 can drive the lens driving unit 152 to move one or more of the lenses 154 along the optical axis according to the lens control command from the camera control unit 110. The lens control command can be, for example, a zoom control command and/or a focusing control command. In some embodiments, the lens driving unit 152 may include at least a portion or all of a voice coil motor (VCM) of the plurality of lenses 154 moving along the optical axis. In some embodiments, the lens driving unit 152 may include a motor, such as a DC motor, a coreless motor, an ultrasonic motor, or the like. The lens driving unit 152 can transfer power from the motor to at least a portion or all of the plurality of lenses 154 via a mechanism component such as a cam ring, a guide shaft, or the like, which can cause at least a portion or all of the plurality of lenses 154 to move along the optical axis.

The camera device 100 can further include a posture control unit or controller 210, an angular velocity sensor 212, and/or an acceleration sensor 214. The angular velocity sensor 212 can detect the angular velocity of the camera device 100. The angular velocity sensor 212 can detect various angular velocities around the roller axis, pitch axis, and/or yaw axis of the camera device 100. The posture control unit 210 can obtain angular velocity information about the angular velocity of the camera device 100 from the angular velocity sensor 212. The angular velocity information may represent various angular velocities around a roller axis, pitch axis, and/or yaw axis of the camera device 100. The posture control unit 210 can obtains acceleration information related to acceleration of the camera device 100 from the acceleration sensor 214. The acceleration information may represent a level of vibration of a magnitude of vibration of the camera device 100. The acceleration information may represent the acceleration of the roller axis, pitch axis, and/or yaw axis of the camera device 100 in respective directions.

In some embodiments, the angular velocity sensor 212 and the acceleration sensor 214 may be disposed within a housing of the image sensor 120 and the lenses 154, a housing of the image sensor 120 or a housing of the lenses 154, or the like. In such embodiments, the camera device 100 and the support mechanism 200 can be configured as a one-piece setting. However, the support mechanism 200 may include a base that removably secures the camera device 100. In this case, the angular velocity sensor 212 and/or the acceleration sensor 214 may be disposed outside the housing of the camera device 100, such as a base of the camera device 100.

In one or more embodiments, the posture control unit 210 can control the support mechanism 200 to maintain and/or change the posture of the camera device 100 based on the angular velocity information and/or the acceleration information. In some embodiments, the posture control unit 210 can control the support mechanism 200 to maintain and/or change the posture of the camera device 100 according to the motion mode of the support mechanism 200 to control the posture of the camera device 100.

In one or more embodiments, the motion mode can include at least one of the roller axis driving mechanism 201, the pitch axis driving mechanism 202, and the yaw axis driving mechanism 203 of the support mechanism 200 to cause a change in the posture of the camera device 100, for instance, to track a pattern of changes in the posture of the base 204 of the support mechanism 200. In some embodiments, the motion mode can include a mode that causes the roller axis driving mechanism 201, the pitch axis driving mechanism 202, and/or the yaw axis driving mechanism 203 of the support mechanism 200 to respectively act, for instance, such that a change in the posture of the camera device 100 may track a change in the posture of the base portion 204 of the support mechanism 200. In some embodiments, the motion mode can include respective actions of the pitch axis driving mechanism 202 and/or the yaw axis driving mechanism 203 of the support mechanism 200, for instance, such that the change in the posture of the camera device 100 may track the change in the posture of the base portion 204 of the support mechanism 200. In some embodiments, the motion mode can include a mode that only causes the yaw axis driving mechanism 203 to act, for instance, such that the change in the posture of the camera device 100 may track the change in the posture of the base portion 204 of the support mechanism 200.

In one or more embodiments, the motion mode may include a first person view (FPV) mode and/or a fixed mode. In the FPV mode, the motion mode may cause the support mechanism 200 to act, for instance, such that a change in the posture of the camera device 100 may track a change in the posture of the base portion 204 of the support mechanism 200. In the fixed mode, the motion mode may cause the support mechanism 200 to act, for instance, such that the posture of the camera device 100 may be maintained.

The FPV mode can be used to move at least one of the roller axis driving mechanism 201, the pitch axis driving mechanism 202, and/or the yaw axis driving mechanism 203, for instance, such that a change in the posture of the camera device 100 may track a change in the posture of the base portion 204 of the support mechanism 200. The fixed mode can be used to operate at least one of the roller axis driving mechanism 201, the pitch axis driving mechanism 202, and/or the yaw axis driving mechanism 203 to maintain the current posture of the camera device 100.

In one or more embodiments, the motion mode may include a tracking mode in which the support mechanism 200 can act to control the posture of the camera device 100, for instance, so that a subject meeting a preset condition can be located in a preset first region in the image captured by the camera device 100. For example, the posture control unit 210 may cause the support mechanism 200 to act to control the posture of the camera device 100, such that the face can be located in a central region in the image captured by the camera device 100.

In the tracking mode, the camera control unit 110 can perform the focusing control, for instance, such that the subject can be focused in the preset first region in the image captured by the camera device 100. In some embodiments, the camera control unit 110 may perform an automatic focusing control based on an image plane phase difference. For example, the camera control unit 110 may perform a phase detection auto focus (PDAF).

The image sensor 120 may have multiple pairs of pixels for image plane phase difference detection. The camera control unit 110 may derive phase difference data (PD data) from multiple pairs of image signals output from multiple pairs of pixels. The camera control unit 110 may determine the defocus amount and the moving direction of the focusing lens according to the PD data. The camera control unit 110 may move the focusing lens according to the determined defocus amount and/or the moving direction of the focusing lens, thereby performing focusing control.

When the dynamic image is captured in the tracking mode, the camera control unit 110 can detect the subject satisfying the preset condition from the frames constituting the dynamic image, and can derive the PD data of the first region including the detected subject. The camera control unit 110 can determine the defocus amount and/or the moving direction of the focusing lens according to the PD data, and can move the focusing lens based on the determined defocus amount and/or the moving direction of the focusing lens, thereby performing focusing control.

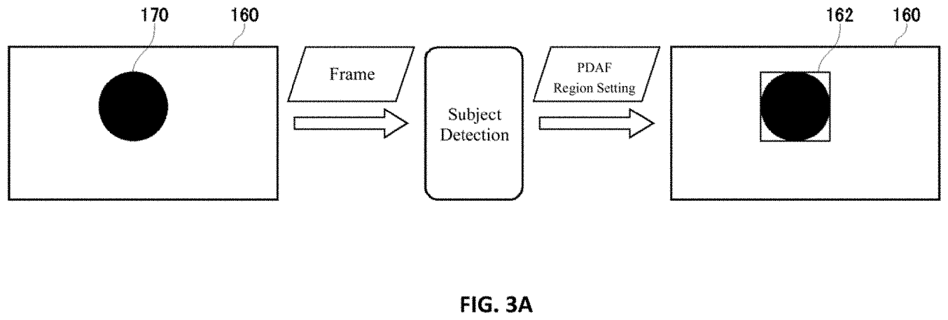

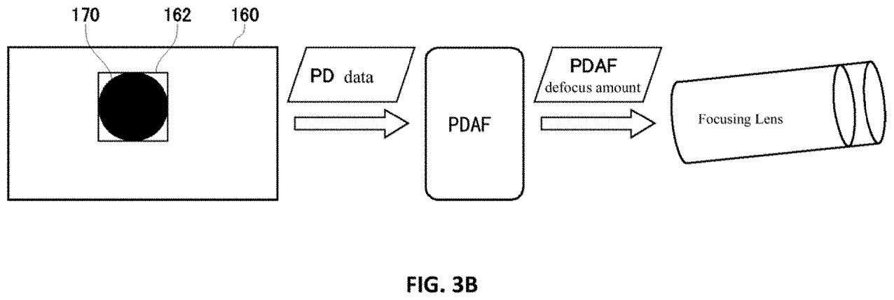

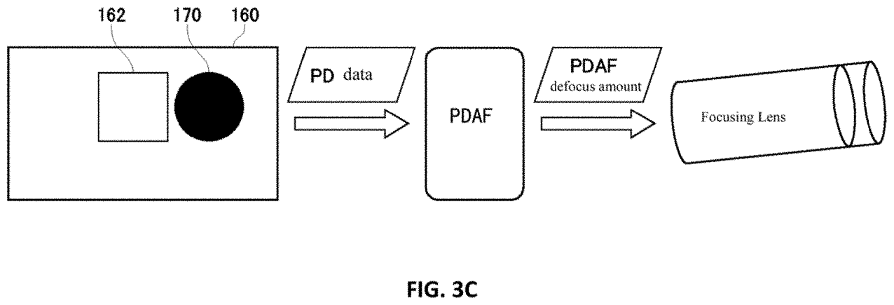

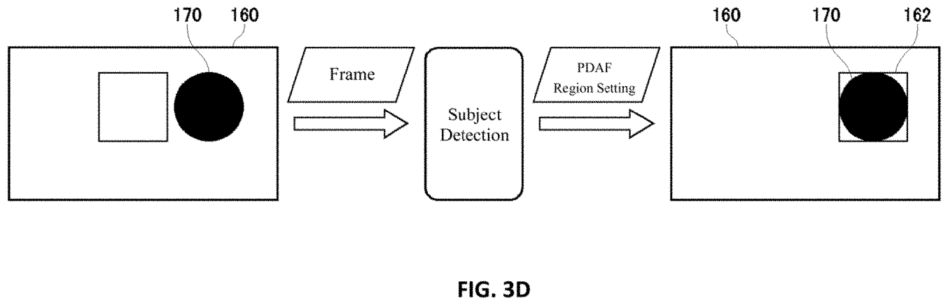

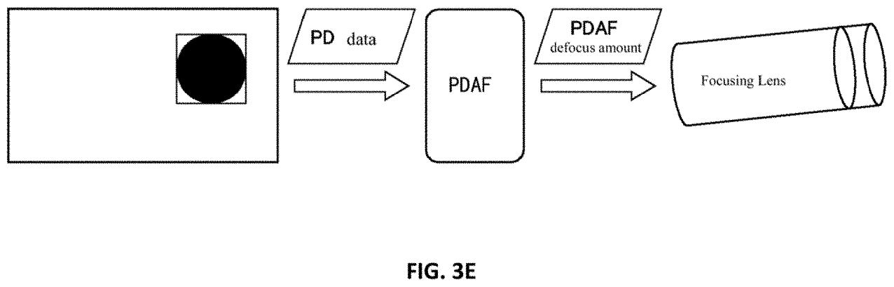

As shown in FIG. 3A, the camera control unit 110 can detect a subject 170 (e.g., an object) satisfying the preset condition from the image 160 captured by the image sensor 120. The camera control unit 110 can define the region 162 where the subject 170 is detected as an area to derive the PD data.

As shown in FIG. 3B, the camera control unit 110 can acquire at least one pair of image signals from at least one pair of pixels included in the preset area for image plane phase difference detection. The camera control unit 110 can derive the PD data from the at least one pair of image signals. The camera control unit 110 can perform phase detection auto focus (PDAF) based on the PD data. For example, the camera control unit 110 can determine the defocus amount and/or the moving direction of the focusing lens according to the PD data, and can move the focusing lens according to the determined defocus amount and/or the moving direction of the focusing lens.

Here, even if the camera system 10 is operated in the tracking mode, because the subject 170 can move, or the user can change the shooting direction of the camera device 100, the posture control unit 210 may temporarily fail to track the subject 170. For example, as shown in FIG. 3C, the subject 170 may move outside the area 162 of the image 160. In this situation, when the focusing lens is moved based on the defocus amount of the PD data in the region 162 and/or the moving direction of the focusing lens, the object 170 may not be present in the region 162, and the camera control unit 110 may instead focus on the background of the region 162. In other words, the camera control unit 110 may not be able to focus on the subject 170 within the image 160.

Then, as shown in FIG. 3D, the camera control unit 110 can detect the subject 170 from the image 160 and can set the region 162 to a position in the image 160 corresponding to the subject 170. Then, as shown in FIG. 3E, the camera control unit 110 can move the focusing lens according to the defocus amount based on the PD data in the new region 162 and/or the moving direction of the focusing lens. Thereby, the camera control unit 110 may focus on the subject 170 within the region 162.

However, the above-described operation may cause the subject 170 within the image 160 captured by the camera device 100 to be temporarily blurred. In the dynamic image taken by the camera device 100, a time period having the temporarily-blurred subject 170 may be generated.

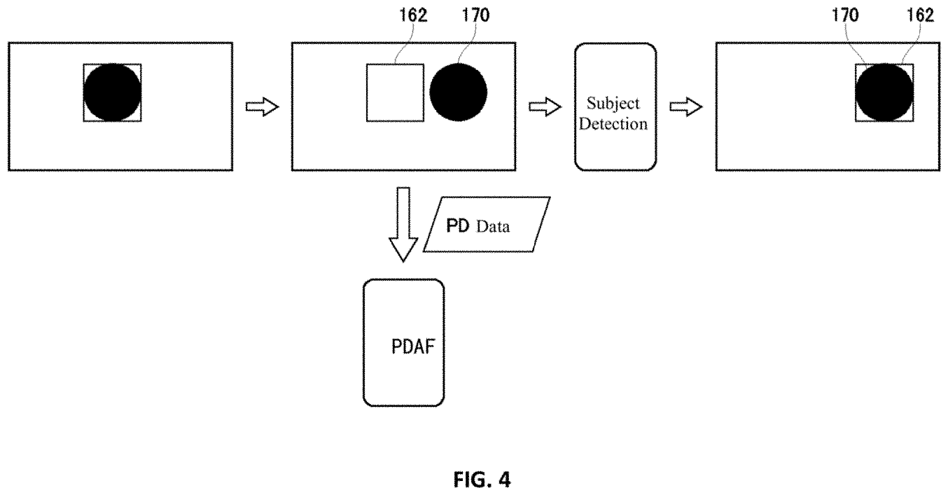

As shown in FIG. 4, the operations of setting the region 162 to detect the subject and deriving the PD data in the region 162 can be performed in parallel, and the PD data of the region 162 can be derived before the region 162 is set based on the detection of the moving subject may not properly reflect the defocus amount of the subject 170. Hence, in the present embodiment, even if the subject 170 moves within the image 160, the focusing state with the subject 170 can be maintained.

The camera control unit 110 can derive the defocus amount for each region 162 of the plurality of regions within the image 160 captured by the camera device 100, and can perform the focusing control of the camera device 100 based on a value of the plurality of defocus amounts representing a closest focus state. Here, the defocus amount is one example of a value representing a focus state. The value of the defocus amount representing the closest focus state may be, for example, a minimum value of a plurality of defocus amounts.

At least two of the plurality of regions may partially overlap. The plurality of regions may include: a first region preset in the image 160, a second region located within the first region in a first direction, a third region located within the first region in a second direction opposite the first direction, a fourth region located within the second region in the first direction, a fifth region located within the third region in the second direction, a sixth region located within the first region in a third direction, a seventh region located within the second region in a fourth direction opposite the third direction, and/or an eighth region located within the third region in the fourth direction. The second region may partially overlap the first region and the fourth region and/or the third region may partially overlap the first region and the fifth region.

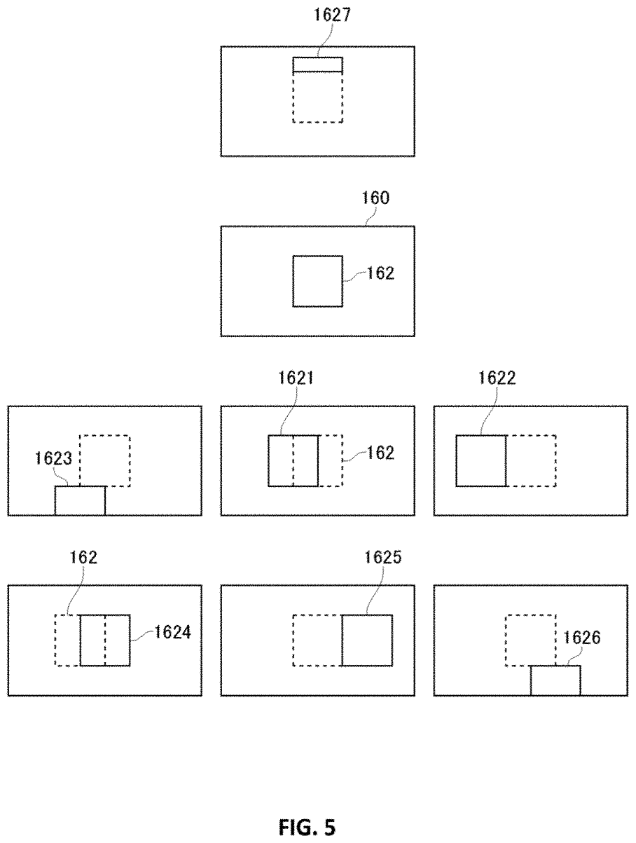

As shown in FIG. 5, the camera control unit 110 may set a plurality of regions including a region 162, a region 1621, a region 1622, a region 1623, a region 1624, a region 1625, a region 1626, and a region 1627. The region 162 can be or can be characterized a central region within the image 160, and the region 162 may be an example of the first region.

In some embodiments, the region 162 can be a preset first region (C region) where the subject is supposed to be located and can satisfy a preset condition in the tracking mode. For example, the first region may be a central region within the image 160. The posture control unit 210 may act to move the support mechanism 200 to control the posture of the camera device 100, for instance, so that the subject 170 is located in the first region. The first region may be a region where the subject 170 is to be focused, which may be a region corresponding to a focus frame. The camera control unit 110 may also display the first region overlapping a preview image as the focus frame on the display unit 302. The camera control unit 110 may display a region other than the first region on the preview image on the display unit 302. In other words, the camera control unit 110 may only display the first region overlapping the preview image as the focus frame on the display unit 302, and in addition, the camera control unit 110 may display the various regions of the plurality of regions overlapping the preview image on the display unit 302. For distinguishing the first region from other regions, the camera control unit 110 may use lines with different thicknesses or colors to display the first region and other regions together on the preview image on the display unit 302.

The region 1621 can be a region (CL region) that can be located on a left side of the region 162 and that can overlap a left portion (e.g., half) of the region 162. The region 1622 can be a region (CLL region) that can be located on the left side of the region 1621 and that can overlap a left portion (e.g., half) of the region 1621. The region 1623 can be a lower-side region (CDL) of the region 1621. The region 1624 can be a region (CR region) that can be located on a right side of the region 162 and that can overlap a right portion (e.g., half) of the region 162. The region 1625 can be a region (CRR region) that can be located on a left side of the region 1624 and that can overlap a right portion (e.g., half) of the region 1624. The region 1626 can be a lower region (CDR region) of the region 1624. The region 1627 can be an upper region (CU region) of the region 162.

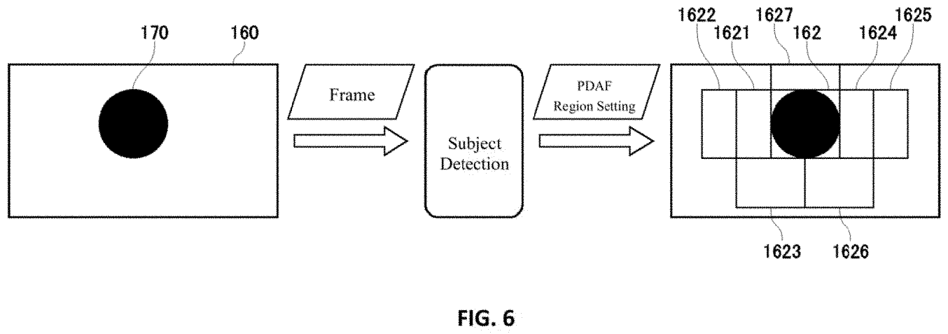

As shown in FIG. 6, the camera control unit 110 can detect the subject 170 in the image 160 to perform the focusing control to focus on the subject 170 in the image 160. The camera control unit 110 can perform an image plane phase difference AF to focus on the subject 170 in the image 160.

The posture control unit 210 can control the posture of the camera device 100, for instance, so that the subject 170 can be located in the preset first region in the image 160, i.e., the region 162. The camera control unit 110 can define the region 162 as a reference position and can further define at least one region around the region 162 to derive the defocus amount. The camera control 110 can define the region 162, the region 1621, the region 1622, the region 1623, the region 1624, the region 1625, the region 1626, and/or the region 1627, as examples.

The camera control unit 110 can derive the defocus amounts for each of the plurality of regions. The camera control unit 110 can move the focusing lens according to a minimum defocus amount in the respective defocus amounts of the plurality of regions. In other words, in addition to the preset region where the subject 170 is supposed to be located, the camera control unit 110 can further derive the defocus amount for other regions around the preset region, and can move the focusing lens according to the minimum defocus amount in these regions. Thus, even if the subject 170 is moved away from the preset region where the subject 170 is supposed to be located, the camera control unit 110 may still focus on the subject 170.

The plurality of regions defined by the camera control unit 110 may also not be eight regions shown in FIG. 5. The plurality of regions may be at least two regions. The number of regions may be set according to the number of regions that the image plane phase difference AF of the camera device 100 may be set.

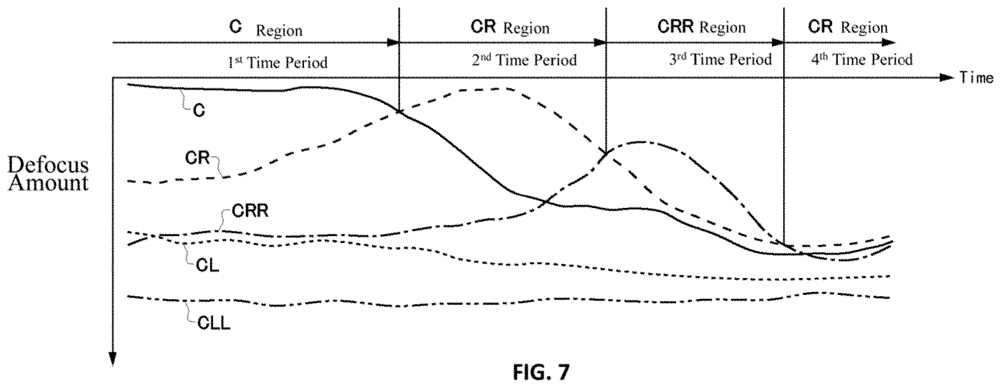

FIG. 7 is an example showing temporal variation of defocus amount Y of the C region, the CR region, the CRR region, the CL region, and the CLL region. As shown in FIG. 7, when the defocus amount changes, the camera control unit 110 can move the focusing lens according to the defocus amount of the C region in the first time period. The camera control unit 110 can move the focusing lens according to the defocus amount of the CR region in the second time period. The camera control unit 110 can move the focusing lens according to the defocus amount of the CRR region in the third time period. The camera control unit 110 can move the focusing lens according to the defocus amount of the CR region in the fourth time period.

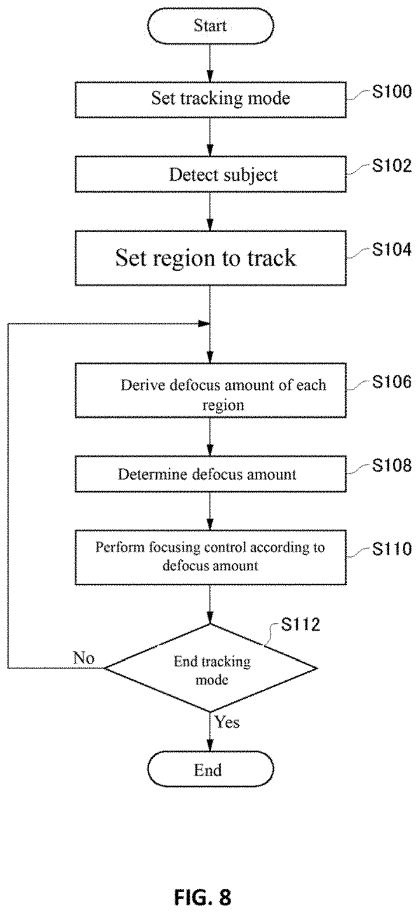

FIG. 8 is a flow diagram illustrating one example of a focusing control process with a camera control unit 110 according to one or more embodiments of the disclosed subject matter.

The camera control unit 110 can set the camera system 10 to the tracking mode according to an instruction sent by the user via the operation interface 301, for instance (S100). The camera control unit 110 can detect a subject satisfying a preset condition, such as a subject representing a face feature, from an image captured by the image sensor 120 (S102).

The camera control unit 110 can set a plurality of regions, including the first region preset in the tracking mode, to a region where the defocus amount can be derived. The posture control unit 210 can act to operate the support mechanism 200 to control the posture of the camera device 100, for instance, so that the detected subject may be located in the first region (S104). The camera control unit 110 can perform the focusing control according to the defocus amount of the region containing the detected subject.

Next, when the posture control unit 210 controls the support mechanism 200 to track the subject, the camera control unit 110 can derive the defocus amount of each of the plurality of regions (S106). The camera control unit 110 can determine a minimum defocus amount in the plurality of defocus amounts (S108). The camera control unit 110 can perform the focusing control according to the determined defocus amount (S110).

If the tracking mode is not complete, the posture control unit 210 can cause the support mechanism 200 to act to cause the subject located in the first region and controls the posture of the camera device 100. The camera control section 110 can continue the process by returning to step S106, for instance.

As described above, in the present embodiment, even if the subject is temporarily offset from the region where the subject supposed to be located, the focusing state with the subject can be also maintained.

In addition, assuming the expected subject is present in the region corresponding to the minimum defocus amount in the respective defocus amounts of the plurality of regions, and the camera control unit 110 may perform the focusing control. However, the expected subject is not necessarily present in the region of the minimum defocus amount.

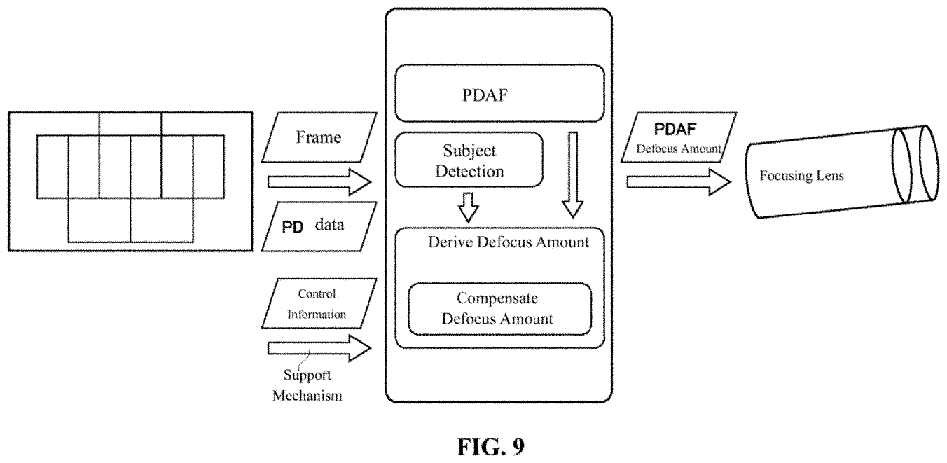

Thus, as shown in FIG. 9, the camera control unit 110 may compensate the minimum defocus amount based on the control information of the support mechanism 200, and may perform the focusing control based on the compensated defocus amount. In the event that the camera system 10 operates in a tracking mode, the support mechanism 200 may act to make the subject located in the first region. The camera control unit 110 can determine the position of the subject according to the control information of the support mechanism 200. When the difference between the region containing the subject and the region corresponding to the minimum defocus amount is small, the possibility that the subject is located in the region corresponding to the minimum defocus amount is high. On the other hand, when the difference between the region containing the subject and the region corresponding to the minimum defocus amount is large, the possibility that the subject is located in the region corresponding to the minimum defocus amount is not high. In other words, the smaller the difference, the higher the reliability of the minimum defocus amount.

The camera control unit 110 may compensate the minimum defocus amount based on a positional relationship between a position of the subject determined in an image captured by the camera device 100 and a region corresponding to a minimum defocus amount in the plurality of regions. The camera control unit 110 may perform a focusing control based on the compensated defocus amount.

The camera control unit 110 may derive a vector representing the moving amount and the moving direction from the first region to the region corresponding to the minimum defocus amount and/or the control information of the support mechanism 200, to determine a difference between the vector representing the moving amount and the moving direction of the image captured by the camera device 100. The camera control unit 110 may compensate the minimum defocus amount based on the difference.

Such processing can prevent the camera control unit 110 from moving the focusing lens more than necessary, for instance, when the reliability of the minimum defocus amount is low.

In addition, in some embodiments, an example of the focusing control performed by the camera control unit 110 through the image plane phase difference AF is disclosed. It is understood that the camera control unit 110 may also perform the focusing control through the phase difference AF, the contrast AF, etc. For example, in the case of using the contrast AF, the camera control unit 110 may derive the contrast value for each region of the plurality of regions including the preset first region where the subject is supposed to be located, and may perform the focusing control according to the value closest to the focus state, i.e., the maximum contrast value.

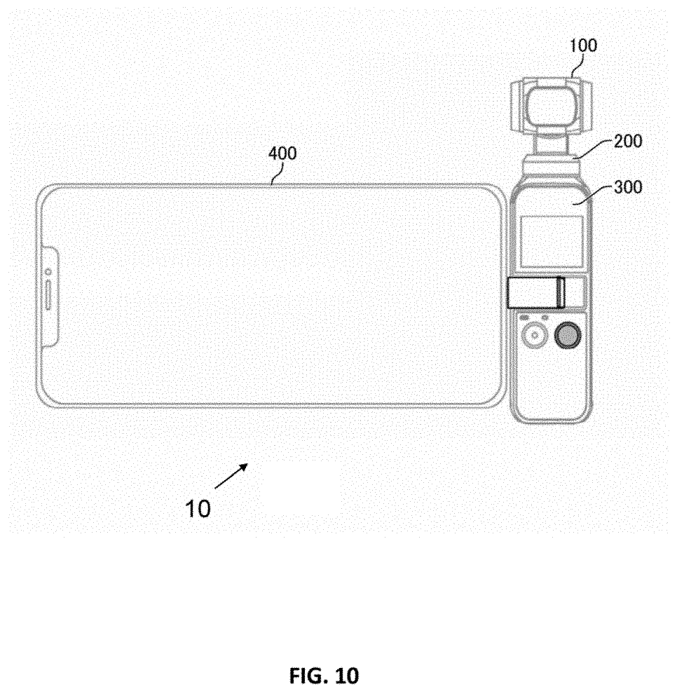

FIG. 10 is a schematic diagram illustrating other implementations of the camera system 10 according to one or more embodiments of the present disclosure. As shown in FIG. 10, the camera system 10 may be used in a situation that to the side of the holding portion 300 is attached a mobile terminal including a display of a smartphone 400 or the like.

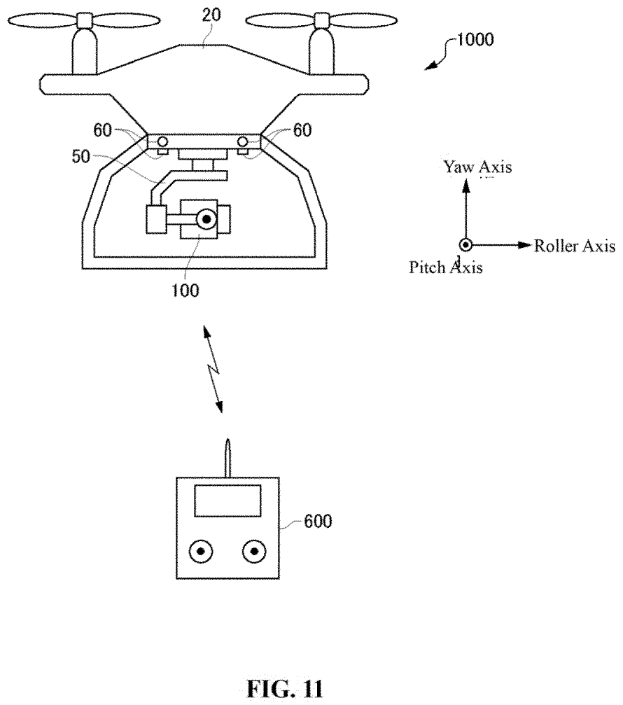

The camera device 100 may also be mounted on a moving body. In some embodiments, the camera device 100 may also be mounted on the unmanned aerial vehicle (UAV), such as shown in FIG. 11. The UAV 1000 may include a UAV body 20, a gimbal 50, a plurality of camera devices 60, and a camera device 100. The gimbal 50 and the camera device 100 may be one example of the camera system. The UAV 1000 is one example of the moving body that is propelled by a propulsion unit. It is understood that the moving body can refer to a moving bodies that includes not only a UAV, but also other aircraft moving in the air, a vehicle moving on the ground, a marine vessel moving in or on water, and the like.

The UAV body 20 can include a plurality of rotors. A plurality of rotors is one example of the propulsion unit. The UAV body 20 can fly the UAV 1000 by controlling the rotation of the plurality of rotors. In some embodiments, the UAV body 20 can employ four rotating wings to cause the UAV 1000 to fly. The number of rotors is not limited to four. In addition, the UAV 1000 may also be a fixed wing without a rotor.

The camera device 100 can be a camera for imaging a subject contained within a desired imaging range. The gimbal 50 can rotatably support the camera device 100. The gimbal 50 may be on example of the support mechanism 200. For example, the gimbal 50 can rotatably support the camera device 100 using an actuator having the pitch axis as a center. For another example, the gimbal 50 can rotatably support the camera device 100 using an actuator having the roller axis and the yaw axis as a center. By rotating the camera device 100 along at least one of the yaw axis, the pitch axis, and/or the roller axis, the gimbal 50 may change the posture of the camera device 100.

The plurality of camera devices 60 can be sensing cameras that capture the surroundings of the UAV 1000 in order to control the flight of the UAV 1000, for instance. Two camera devices 60 may be disposed on a head, e.g., the front area, of the UAV 1000. Another two camera devices 60 may be disposed on a bottom side of the UAV 1000. The two camera devices 60 on the front area may be paired to function as a so-called stereo camera. The two camera devices 60 on the bottom side may also be paired to function as a stereo camera. Three-dimensional space data around the UAV 1000 may be generated based on images captured by the plurality of camera devices 60. The number of camera devices 60 included in the UAV 1000 is not limited to four. In some embodiments, the UAV 1000 may include at least one camera device 60. The UAV 1000 may also include at least one camera device 60 at the head, the tail, the side, the bottom, and/or the top surfaces of the UAV 1000, respectively. A visual angle of the camera device 60 may be larger than a visual angle provided in the camera device 100. The camera device 60 may also have a single-focus lens or a fisheye lens.

A remote operating device 600 can communicate with the UAV 1000 to remotely operate the UAV 1000. The remote operating device 600 may wirelessly communicate with the UAV 1000. The remote operating device 600 can transmit information indicating various instructions related to movement of the UAV 1000 to the UAV 1000 indicating up, down, acceleration, deceleration, forward, backward, rotation, etc. The information can include, for example, indication information that causes a height of the UAV 1000 to change. The indication information may indicate a height at which the UAV 1000 should be located. The UAV 1000 can move to a height represented by the indication information received from the remote operating device 600. The indication information may include a change height instruction (e.g., a rise instruction) that causes the UAV 1000 to change height (e.g., rise). The UAV 1000 rises during the period of acceptance of the rise instruction. When the height of the UAV 1000 has reached a upper limit height, the UAV 1000 may also be limited to rise even if a rise instruction is accepted.

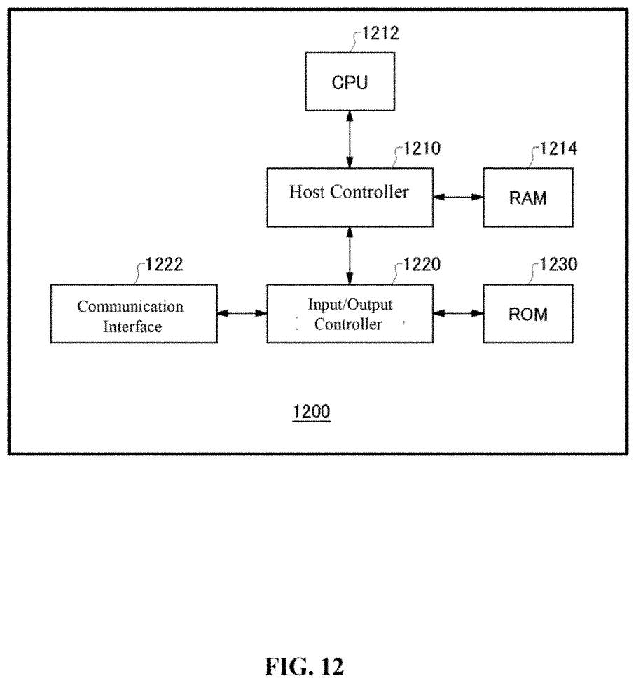

FIG. 12 illustrates one example of a computer 1200 that may embody aspects of the present disclosure in whole or in part. The program installed on the computer 1200 can cause the computer 1200 to function as an operation associated with the apparatus involved in the embodiments of the present disclosure or one or more “sections” of the apparatus. Alternatively, the program can cause the computer 1200 to perform the operation or the one or more “sections.” The program can cause the computer 1200 to perform the processes involved in the embodiments of the disclosure or the stages of the process. Such programs may be executed by the CPU 1212 to cause the computer 1200 to perform the specified operations associated with some or all of the flowcharts and block diagrams described herein, such as some or all of those shown in FIG. 8.

The computer 1200 of the present embodiment can include a CPU 1212 and a RAM 1214, which can be interconnected by a host controller 1210. The computer 1200 can also include a communication interface 1222 and input/output units, which can be connected to the host controller 1210 through an input/output controller 1220. The computer 1200 can also include a ROM 1230. The CPU 1212 can operate according to programs stored in the ROM 1230 and the RAM 1214 to control the units.

The communication interface 1222 can communicate with other electronic devices via a network. The hard disk drive may store programs and data used by the CPU 1212 within the computer 1200. The ROM 1230 can store programs that are executed by the computer 1200 and/or relied on the hardware of the computer 1200. The program can be provided by a computer-readable medium or network such as a CD-ROM, USB memory, or IC card. The program can be installed in the RAM 1214 and/or the ROM 1230, which are also examples of a computer-readable medium, and can be executed by the CPU 1212. The information described in these programs can be read by the computer 1200 and can cause collaboration between the program and the various types of hardware resources described above. The operations or processes of the information may be implemented by the computer 1200 to form an apparatus or method.

For example, when communicating between the computer 1200 and the external device, the CPU 1212 may execute a communication program loaded in the RAM 1214 and command the communication interface 1222 for communication processing based on the processing described in the communication program. Under the control of the CPU 1212, the communication interface 1222 can read the transmission data stored in the transmission buffer provided in the recording medium, such as the RAM 1214 or the USB memory, and can send the read data to the network, or can write the received data received from the network to the receiving buffer provided on the recording medium, etc.

In addition, the CPU 1212 may cause the RAM 1214 to read all or essential portions of a file or database stored in an external recording medium, such as USB memory, and can perform various types of processing on the data on the RAM 1214. The CPU 1212 may then write the processed data back into the external recording medium.

Various types of information, such as various types of programs, data, tables, and databases, may be stored in the recording medium and subjected to information processing. For data read from the RAM 1214, the CPU 1212 may perform various types of processing described throughout this disclosure, including various types of operations specified by the sequence of instructions of the program, information handling, conditional decision, conditional branch, unconditional branch, retrieval/replacement of information, etc., and write the results back into the RAM 1214. In addition, the CPU 1212 may retrieve information in a file, a database, or the like within the recording medium. For example, when a plurality of entries having attribute values of the first attribute associated with the attribute values of the second attribute are stored in the recording medium, the CPU 1212 may retrieve an entry matching the condition of the attribute value specifying the first attribute from the associated plurality of entries and read the attribute value of the second attribute stored within the entry to obtain an attribute value of the second attribute associated with the first attribute that satisfies the preset condition.

The above-described program or software modules may be stored on a computer 1200 or on a non-transitory computer-readable medium associating the computer 1200. In addition, a recording medium, such as a hard disk or RAM, provided in a server system connected to a private communication network or the Internet may be used as a non-transitory computer-readable medium, such that the program may be provided to the computer 1200 via a network.

It should be noted that relational terms, such as first and second, etc., are used herein to distinguish one entity or operation from another entity or operation without necessarily requiring or implying any such actual relationship or order between such entities or operations. The terms “comprises,” “comprising,” or any other variation thereof, are intended to cover a non-exclusive inclusion, such that a process, method, article, or apparatus that comprises a series of elements not only includes those elements but also includes other elements not expressly listed, or that is an element inherent to such process, method, article, or apparatus. In the absence of more constraints, elements defined by the term “comprises a . . . ” do not preclude the presence of additional similar elements in the process, method, article, or apparatus that includes the element.

The present disclosure has been described in detail with reference to the principles and implementations of the present disclosure. The foregoing description of the embodiments has been presented only to aid in the understanding of the methods of the present disclosure and its core idea. For a person of ordinary skill in the art, in accordance with the concepts of the present disclosure, it is not to be understood that the present specification is not to be construed as a limitation on the present disclosure.

What is claimed is:

1. A control device comprising circuitry configured to:
derive a plurality of focus state values representing focus states for each region of a plurality of regions within an image captured by a camera device; and
perform a focusing control of the camera device based on a value of the plurality of focus state values representing a closest focus state.

2. The control device of claim 1, wherein the circuitry is configured to:
determine a subject satisfying a preset condition based on the image captured by the camera device;
perform the focusing control to focus on the subject; and
derive the plurality of focus state values for each region of the plurality of regions that includes a first region in which the subject is located.

3. The control device of claim 2, wherein the camera device is mounted on a support mechanism configured to control a posture of the camera device, and the support mechanism controls the posture of the camera device to make the subject located in the first region.

4. The control device of claim 3, wherein the circuitry is configured to rotate the camera device around at least one of a roller axis, a pitch axis, and a yaw axis, by use of the support mechanism.

5. The control device of claim 3, wherein the circuitry is configured to cause a change in the posture of the camera device to track a posture change of a base of the support mechanism.

6. The control device of claim 3, wherein the circuitry is configured to cause the support mechanism to act such that the posture of the camera device is maintained.

7. The control device of claim 3, wherein a first region of the plurality of regions corresponds to a central region in the image captured by the camera device.

8. The control device of claim 7, wherein a face is located in the first region in the image captured by the camera device.

9. The control device of claim 3, wherein the circuitry is configured to:
compensate the value representing the closest focus state based on control information associated with the support mechanism; and
perform the focusing control based on the compensated value.

10. The control device of claim 3, wherein the circuitry is configured to:
compensate the value representing the closest focus state based on a positional relationship between a position of the subject determined based on the image captured by the camera device and a region corresponding to the value representing the closest focus state; and
perform the focusing control based on the compensated value.

11. The control device of claim 1, wherein the circuitry is configured to perform the focusing control according to an automatic focusing control based on a phase difference.

12. The control device of claim 1, wherein at least two of the plurality of regions are partially overlapped.

13. The control device of claim 1, wherein the plurality of regions comprise:
a first region preset in the image captured by the camera device;
a second region located within the first region in a first direction;
a third region located within the first region in a second direction opposite the first direction;
a fourth region located within the second region in the first direction;
a fifth region located within the third region in the second direction;
a sixth region located within the first region in a third direction;
a seventh region located within the second region in a fourth direction opposite the third direction; and
an eighth region located within the third region in the fourth direction.

14. The control device of claim 12, wherein the second region partially overlaps the first region and the fourth region, and the third region partially overlaps the first region and the fifth region.

15. The control device of claim 12, wherein the first region is in a central region of the image captured by the camera device.

16. The control device of claim 1, wherein the value of the plurality of focus state values representing the closest focus state is a minimum value of respective values corresponding to the plurality of focus states.

17. A camera device, comprising:
a control device having circuitry configured to:
derive a plurality of focus state values representing focus states for each region of a plurality of regions within an image, and
perform a focusing control of the camera device based on a value of the plurality of focus state values representing a closest focus state;
a focusing lens configured to be controlled by the control device; and
an image sensor configured to capture the image.

18. A camera system, comprising:
the camera device according to claim 17; and
a supporting mechanism configured to control posture of the camera device.

19. An image capturing method, comprising:
deriving, using an electronic processor, a plurality of focus state values representing focus states for each region of a plurality of regions within an image captured by a camera device; and
performing, using the electronic processor, a focusing control of the camera device based on a value of the plurality of focus state values representing a closest focus state.

20. A non-transitory computer-readable storage medium having stored thereon instructions that, when executed by one or more processors, causes the one or more processors to perform the method according to claim 19.
